(19) United States
(12) Patent Application Publication
(10) Pub. No.: US 2009/0289754 A1
(43) Pub. Date: Nov. 26, 2009

(54) Magnetic Induction Device

(75) Inventors: Zeev Shpiro, Tel Aviv (IL); Alex Axelrod, Moshav Haniel (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: AMS ADVANCED MAGNETIC SOLUTIONS, LIMITED, Wanchai (HK)

(21) Appl. No.: 11/721,437

(22) PCT Filed: Dec. 13, 2005
(86) PCT No.: PCT/IL05/01343

§ 371 Date: Jun. 12, 2007

Related U.S. Application Data
(60) Provisional application No. 60/635,517, filed on Dec. 14, 2004.

(51) Int. Cl. H01F 27/36; H01F 27/28

(52) U.S. Cl. 336/84 C; 336/220

(57) ABSTRACT

A magnetic induction device (MID) is described. The MID comprises at least one primary electrical winding, at least one secondary electrical winding, and an electrically-conductive cover (BCC) which is electrically connected to a local ground and at least partially surrounds, without forming a closed conductive loop, a core via which the at least one primary electrical winding and the at least one secondary electrical winding are magnetically coupled. Related apparatus and methods are also described.

### FIELD OF THE INVENTION

The present invention generally relates to magnetic induction devices and to circuitries that use magnetic induction devices.

### BACKGROUND OF THE INVENTION

Magnetic induction devices, such as transformers and Baluns (Balun—Balanced-Unbalanced), are typically used in various systems, such as in communication systems. Conventional transformers, when used with balanced signals, are typically not sufficiently effective in rejecting common-mode (CM) currents in a frequency band above several hundreds of MHz. Sufficiently high CM rejection is especially important at high-speed data communication applications for prevention of conducted and radiated emissions, and for enhancement of data interface noise immunity.

Ineffectiveness of the conventional signal transformers in rejecting CM currents resulted till now in complex magnetics devices and designs being used in order to obtain a solution for communication applications. Such complex devices and designs are typically utilized in 10/100/1000BaseT Ethernet applications and include a combination of a line transformer and a common-mode choke for each line pair. If Power-over-Ethernet (POE) applications are also to be supported in such devices and designs, then an auto-transformer is also added for each line pair thus further increasing the number of magnetic induction devices per line pair. Complexity of magnetics design led to imbalance problems, which in turn are a source of electromagnetic interference (EMI) problems and crosstalk. Examples of such complex devices and designs are shown in the following data sheets:

A data sheet LM00200 dated 2004, of Bel Fuse, Inc., of Jersey City, N.J., USA, which describes Voice over IP magnetics and broadband transformers, incorporating line transformers, common-mode chokes and auto-transformers;

A data sheet of PCA Electronics, Inc. of North Hills, Calif., USA, which describes the 1000Base-T Modules EPG4001AS and EPG4001AS-RC, incorporating line transformers, common-mode chokes and auto-transformer;

A data sheet H327.H dated August 2005, of Pulse® of San Diego, Calif., USA, which describes Power over Ethernet (PoE) Magnetics and 10/100BASE-TX VoIP Magnetics Modules, incorporating line transformers, common-mode chokes and auto-transformer;

A data sheet of Midcom, Inc. of South Dakota, USA, dated Dec. 11, 2005, which is available at the company website www.midcom-inc.com and describes the EDSO-G24 Discrete Single Port Gigabit magnetic component; and

A data sheet of Xmultiple, of California USA, dated 30 Jun. 2003, which describes the XRJH RJ45 Connector which incorporates line transformers and common-mode chokes.

Problems associated with conventional designs of high-speed local-area network (LAN) magnetics are described and explained in a presentation entitled “EMI Considerations in Selection of Ethernet Magnetics”, by Neven Pischl of Broadcom Corporation, presented in the Santa Clara Chapter Meeting of the IEEE EMC Society, May 11, 2004.

Improvements in electrical performance of magnetic induction devices at high-frequencies are therefore desired.

Some aspects of technologies and related material that propose solutions for controlling leakage inductance in magnetic components but do not solve the problem of common-mode rejection are described in the following publications:

U.S. Pat. No. 3,123,787 to Shifrin, which describes toroidal transformer having a high turns ratio;

U.S. Pat. No. 5,719,544 to Vinciarelli et al, which describes a transformer with controlled interwinding coupling and controlled leakage inductances and circuit using such transformer; and

U.S. Pat. No. 6,720,855 to Vicci, which describes a magnetic flux guiding apparatus which comprises a conduit having a wall that comprises an electrically conducting material.

Some aspects of technologies and related material that deal with reduction of interwinding capacitance in isolation transformers and result in some enhancement of common-mode rejection but do not address the problem of controlling leakage inductance are described in the following publications:

U.S. Pat. No. 4,484,171 to McLoughlin, which describes a shielded transformer of the type particularly used as an isolation transformer, that has a greatly reduced interwinding capacitance;

U.S. Pat. No. 4,464,544 to Klein, which describes a corona effect sound emitter including a discharge electrode producing corona discharge and surrounded by a spherical counter electrode which is partially inserted in a housing which encloses a high frequency generator, modulation transformer and a power supply transformer of which the power supply transformer supplies the discharge electrode with electric current;

U.S. Pat. No. 3,851,287 to Miller, et. al., which describes a low leakage current electrical isolation system; and

Published U.S. Pat. No. Application 2005/0162237 of Yamashita, which describes a communication transformer that includes a magnetic core, a plurality of transfer-purpose windings wound on the magnetic core, and an additional winding which is wound on the magnetic core in such a manner that the additional winding is positioned between the plurality transfer-purpose windings, and which does not contribute in signal transfer operations.

The disclosures of all references mentioned above and throughout the present specification, as well as the disclosures of all references mentioned in those references, are hereby incorporated herein by reference.

### SUMMARY OF THE INVENTION

The present invention, in preferred embodiments thereof, seeks to provide magnetic induction devices (MIDs) that are operable in a wide range of frequencies, and offer enhanced performance at high-frequencies, such as at frequencies of the order of hundreds of MHz and beyond. The enhanced performance at high-frequencies, as well as performance at lower frequencies, makes the MIDs in accordance with the present invention particularly useful in high-speed data communication applications and in power supply applications particularly at high switching frequencies, i.e., 500 kHz and beyond.

In contrast with conventional MIDs and conventional MID designs, the MIDs in accordance with the present invention provide both improvement in control of leakage inductance and enhancement of common-mode rejection, all on a single device basis.

The term “magnetic induction device” (MID) is used throughout the present specification and claims to include a device that uses magnetic induction and electrical currents induced by magnetic flux, typically in electrical and magnetic circuitry employed for various applications. Examples, which are not meant to be limiting, of a MID include at least one of the following: a transformer; a Balun; an electrical power divider; an electrical power splitter; an electrical power combiner; a common-mode (CM) choke; a mixing device based on magnetic induction components; a modulator; and an inductor.

Further objects and features of the present invention will become apparent to those skilled in the art from the following description and the accompanying drawings.

There is thus provided in accordance with a preferred embodiment of the present invention a magnetic induction device (MID) including at least one primary electrical winding, at least one secondary electrical winding, and an electrically-conductive cover (ECC) which is electrically connected to a local ground and at least partially surrounds, without forming a closed conductive loop, a core via which the at least one primary electrical winding and the at least one secondary electrical winding are magnetically coupled.

Preferably, the ECC at least partially surrounds the following core sections: a core section surrounded by the at least one primary electrical winding, a core section surrounded by the at least one secondary electrical winding, and a core section between the at least one primary electrical winding and the at least one secondary electrical winding.

Further preferably, the ECC surrounds the core section surrounded by the at least one primary electrical winding under the winding so as to provide a conductive path for surface currents induced by the at least one primary electrical winding from an outer surface of the ECC which is in proximity to the at least one primary electrical winding to an inner surface of the ECC which is in proximity to the core.

Alternatively or additionally, the ECC surrounds the core section surrounded by the at least one secondary electrical winding under the winding so as to provide a conductive path for surface currents induced by magnetic flux in the core from an inner surface of the ECC which is in proximity to the core to an outer surface of the ECC which is in proximity to the secondary electrical winding.

Also alternatively, the ECC surrounds the core section surrounded by the primary electrical winding and the core section surrounded by the secondary electrical winding from above the windings and is substantially in contact with winding insulation of at least a portion of the windings to substantially prevent leakage of a magnetic flux emanating from the primary electrical winding.

Preferably, the ECC is electrically connected to the local ground via at least one of the following connections: a direct connection, a connection via a capacitor, and a connection via low-impedance circuitry.

The local ground preferably includes at least one of the following: a local conductive chassis ground, a shield of host equipment, a housing of host equipment, a massive printed circuit ground plane, and a massive conductive plate.

The magnetic induction device preferably includes at least one of the following: a transformer, a Balun, an electrical power divider, an electrical power splitter, an electrical power combiner, a common-mode (CM) choke, a mixing device based on magnetic induction components, and a modulator.

Preferably, the ECC is electrically connected to the local ground at least at a location along a core section which is between the at least one primary electrical winding and the at least one secondary electrical winding.

The core preferably includes a closed path for magnetic flux defining a window in the core, the window being at least partially filled with an electrically conductive medium comprising a heat-sink and connected to the local ground.

Preferably, at least one of the at least one primary electrical winding and the at least one secondary electrical winding includes a ribbon cable in which each wire is electrically connected, at at least one location, to adjacent wires in the ribbon cable so as to produce a conductive path throughout all wires in the ribbon cable.

Alternatively or additionally, at least one of the at least one primary electrical winding and the at least one secondary electrical winding includes an insulated conductor produced by a metal deposition technique used for depositing a conductor followed by deposition of an insulation layer that insulates the conductor.

Further alternatively or additionally, at least a portion of at least one of the at least one primary electrical winding and the at least one secondary electrical winding includes an inner conductor of a coaxial cable, and the magnetic induction device also includes an additional ECC which includes an outer shielding conductor of the coaxial cable, the coaxial cable being arranged so as not to form a closed conductive loop around the core.

The magnetic induction device may preferably be comprised in and/or associated with a line termination unit (LTU) which is used in Ethernet communication.

There is also provided in accordance with a preferred embodiment of the present invention a magnetic induction device including a primary electrical winding including a first ribbon cable in which each wire is electrically connected, at at least one location, to adjacent wires in the first ribbon cable so as to produce a conductive path throughout all wires in the first ribbon cable, and a secondary electrical winding including a second ribbon cable in which each wire is electrically connected, at at least one location, to adjacent wires in the second ribbon cable so as to produce a conductive path throughout all wires in the second ribbon cable.

Further in accordance with a preferred embodiment of the present invention there is provided an inductor including an electrically-conductive cover (ECC) which at least partially surrounds a core without forming a closed conductive loop, and an electrical winding wound on the ECC.

Preferably, the ECC is grounded.

Yet further in accordance with a preferred embodiment of the present invention there is provided a method of reducing leakage inductance and enhancing common-mode (CM) signal rejection in a magnetic induction device, the method including providing at least one primary electrical winding, and at least one secondary electrical winding, at least partially surrounding a core via which the at least one primary electrical winding and the at least one secondary electrical winding are magnetically coupled, by an electrically-conductive cover (ECC) without forming a closed conductive loop, and electrically connecting the ECC to a local ground.

There is also provided in accordance with a preferred embodiment of the present invention a method of reducing metallic losses in a magnetic induction device, the method including providing a ribbon cable, electrically connecting each wire in the ribbon cable, at at least one location, to adjacent wires in the ribbon cable so as to produce a conductive path throughout all wires in the ribbon cable, and wrapping the ribbon cable around a core of a magnetic induction device so as to produce an electrical winding of the magnetic induction device.

Further in accordance with a preferred embodiment of the present invention there is provided a method for reducing leakage inductance in an inductor, the method including at least partially surrounding a core by an electrically-conductive cover (ECC) without forming a closed conductive loop, and winding an electrical winding on the ECC.

### BRIEF DESCRIPTION OF THE DRAWINGS

The present invention will be understood and appreciated more fully from the following detailed description, taken in conjunction with the drawings in which:

FIG. 1A is a simplified pictorial illustration of a preferred implementation of a magnetic induction device (MID) comprising a transformer which employs a grounded Electrically-Conductive Cover (ECC), the MID being constructed and operative in accordance with a preferred embodiment of the present invention;

FIG. 1B is a simplified pictorial illustration of a cross-section view of the MID of FIG. 1A;

FIG. 2 is a simplified pictorial illustration of current path on a surface of the ECC at a cross section of the MID of FIG. 1A;

FIG. 3 is a simplified pictorial illustration of another preferred implementation of a MID comprising a transformer which employs a grounded ECC over windings, the MID being constructed and operative in accordance with a preferred embodiment of the present invention;

FIG. 4 is a simplified pictorial illustration of yet another preferred implementation of a MID comprising a transformer which has windings one over the other and employs a grounded ECC, the MID being constructed and operative in accordance with a preferred embodiment of the present invention;

FIG. 5A is a simplified pictorial illustration of still another preferred implementation of a MID comprising a transformer which employs a grounded ECC and sleeves added over the ECC between windings and grounding location, the MID being constructed and operative in accordance with a preferred embodiment of the present invention;

FIG. 5B is an illustration of an equivalent circuit applicable for evaluation of CM rejection of the MID of FIG. 5A;

FIG. 6 is a graph showing typical common-mode (CM) rejection performance of the MID of FIG. 5A at different values of a ratio between ECC inductance and inductance of grounding bond;

FIG. 7A is a simplified pictorial illustration of a cross-section view of yet another preferred implementation of a MID comprising a transformer which employs a grounded ECC and has a core window which is at least partially filled with a conductive medium, the MID being constructed and operative in accordance with a preferred embodiment of the present invention;

FIG. 7B is a simplified pictorial illustration of a top view of the MID of FIG. 7A;

FIG. 8A is a simplified pictorial illustration of another preferred implementation of a MID comprising a transformer which employs a grounded ECC and coaxial cable wiring, the MID being constructed and operative in accordance with a preferred embodiment of the present invention;

FIG. 8B is a simplified pictorial illustration of a cross-section view of tie MID of FIG. 8A;

FIG. 9A is an illustration of an electrical circuit of a prior art magnetics module for a 100/1000BaseT Ethernet interface circuit that also supports Power-over-Ethernet (POE);

FIG. 9B is an illustration of an electrical circuit of a MID comprising a transformer which employs a grounded ECC in accordance with a preferred embodiment of the present invention, the electrical circuit being constructed and operative in accordance with a preferred embodiment of the present invention;

FIG. 10 is a simplified pictorial illustration of a preferred implementation of a MID comprising an inductor which employs a grounded ECC, the MID being constructed and operative in accordance with a preferred embodiment of the present invention;

FIG. 11 is a simplified flowchart illustration of a preferred method for constructing any of the MIDs of FIGS. 1, 3-5A and 7A-8B;

FIG. 12 is a simplified flowchart illustration of a preferred method for constructing a MID having reduced metallic losses and comprising a ribbon cable; and

FIG. 13 is a simplified flowchart illustration of a preferred method for constructing the inductor of FIG. 10.

### DETAILED DESCRIPTION OF A PREFERRED EMBODIMENT

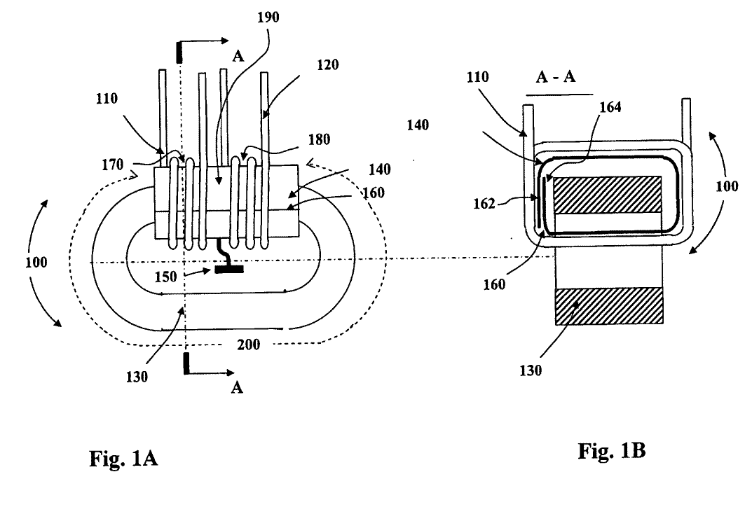

Reference is now made to FIG. 1A, which is a simplified pictorial illustration of a preferred implementation of a magnetic induction device (MID) 100 comprising a transformer which employs a grounded Electrically-Conductive Cover (ECC), the MID 100 being constructed and operative in accordance with a preferred embodiment of the present invention.

The MID 100 may, for example which is not meant to be limiting, be used as a transformer in various applications including, for example, communication applications. The MID 100 preferably includes the following elements: at least one primary electrical winding 110; at least one secondary electrical winding 120; a core 130 via which the at least one primary electrical winding 110 and the at least one secondary electrical winding 120 are magnetically coupled; and an ECC 140. For simplicity of description and depiction, only one primary electrical winding 110 and one secondary electrical winding 120 are shown in FIG. 1A and referred to below, but it is appreciated that the number of primary electrical windings and secondary electrical windings is not meant to be limiting, and rather the MID 100 may include more than one primary electrical winding 110 and/or more than one secondary electrical winding 120.

Each of the primary electrical winding 110 and the secondary electrical winding 120 may comprise insulated wires or insulated conductors. The insulated conductors may, for example, be produced by an appropriate metal deposition technique used for depositing a conductor followed by deposition of an insulation layer that insulates the conductor. The metal deposition technique may, for example, comprise multilayer metal deposition.

The core 130 may comprise a magnetic core or an air core, or a combination comprising a magnetic core and an air core or other materials. The ECC 140 may, for example which is not meant to be limiting, comprise at least one of the following: a solid metallic material, such as copper or aluminum; a metallic mesh; thin layers of metal deposition; and a conductive paint.

In accordance with a preferred embodiment of the present invention the ECC 140 is electrically connected to a local ground 150 and at least partially surrounds the core 130, without forming a closed conductive loop. In order to prevent formation of the closed conductive loop the ECC 140 preferably includes a gap 160 which may comprise a longitudinal gap. The gap 160 may comprise a non-conducting material or adhesive. A cross-section view of a layout of the ECC 140 with the gap 160 is shown in FIG. 1B, which is a simplified pictorial illustration of a cross-section view of the MID 100.

Preferably, the ECC 140 is electrically connected to the local ground 150 via at least one of the following connections: a direct connection; a connection via a capacitor; and a connection via low-impedance circuitry.

As also shown in FIG. 1B, the ECC 140 may, for example which is not meant to be limiting, completely surround the core 130 with an overlap section 162 over a section 164, and the gap 160 is preferably between the sections 162 and 164.

Placement of the primary electrical winding 110 and the secondary electrical winding 120 along the core preferably defines four types of sections of the core 130: a core section 170 surrounded by the primary electrical winding 110; a core section 180 surrounded by the secondary electrical winding 120; and two core sections 190 and 200 that are not surrounded by the primary electrical winding 110 or by the secondary electrical winding 120. The core sections 190 and 200 are between the primary electrical winding 110 and the secondary electrical winding 120.

Preferably, the ECC 140 at least partially surrounds the following core sections: the core section 170; the core section 180; and the core section 190, and the ECC 140 is preferably electrically connected to the local ground 150 at least at a location along the core section 190. It is appreciated that the ECC 140 does not need to completely surround the core section 200. The ECC 140 may alternatively at least partially surround the core section 200 instead of the core section 190 to achieve a similar result, under the condition that in such a case the ECC 140 is electrically connected to the local ground 150 at least at a location along the core section 200.

The ECC 140 may at least partially surround the core sections 170 and 180 either under the windings 110 and 120 or from above the windings 110 and 120. Alternatively, the ECC 140 may at least partially surround the core section 170 under the is winding 110 and the core section 180 from above the winding 120, or at least partially surround the core section 170 from above the winding 110 and the core section 180 under the winding 120.

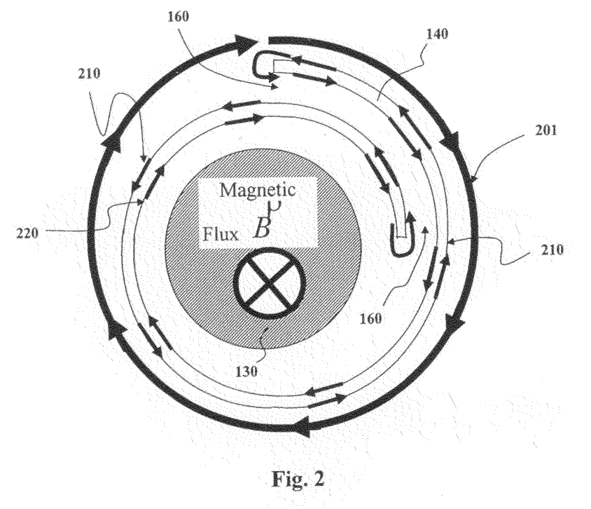

In a case where the ECC 140 at least partially surrounds the core section 170 under the winding 110, the ECC 140 preferably enables a conductive path for surface currents induced by the primary electrical winding 110 from an outer surface of the ECC 140 which is in proximity to the primary electrical winding 110 to an inner surface of the ECC 140 which is in proximity to the core 130. Current path on the ECC 140 surface at a cross section of the MID 100 in such a case is shown in FIG. 2.

In FIG. 2, reference numeral 201 indicates current flowing in the primary electrical winding 110, for example in a clockwise direction. The current 201 induces current 210 flowing in a counterclockwise direction on the outer surface of the ECC 140 and then proceeding clockwise on the inner surface of the ECC 140 which is in proximity to the core 130. The current 210 proceeds to the inner surface of the ECC 140 along the gap 160, and produces current 220 flowing along the inner surface of the ECC 140. The current 220 proceeds back to the outer surface of the ECC 140 along the gap 160.

The current 220 flowing on the inner surface of the ECC 140 under the primary electrical winding 110 generates a magnetic flux in the core 130. Such magnetic flux propagates along the core 130 thus generating surface currents on the inner surface of the ECC 140.

Referring now back to FIG. 1A, in a case where the ECC 140 at least partially surrounds the core section 180 under the secondary winding 120, the ECC 140 preferably enables a conductive path for surface currents, induced by magnetic flux in the core 130, from an inner surface of the ECC 140 which is in proximity to the core 130, to an outer surface of the ECC 140 which is in proximity to the secondary electrical winding 120.

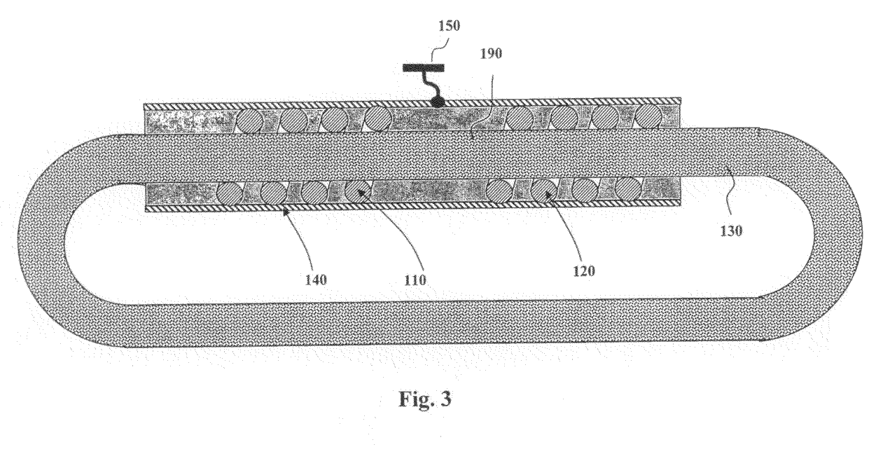

In a case where the ECC 140 at least partially surrounds the core sections 170 and 180 from above the windings, the ECC 140 is preferably mounted substantially in contact with winding insulation of at least a portion of the windings 110 and 120 to substantially prevent leakage of a magnetic flux emanating from the primary electrical winding 110 and the secondary winding 120. Such a case is shown in FIG. 3.

The local ground 150 preferably comprises at least one of the following; a local conductive chassis ground; a shield of host equipment; a housing of host equipment; a massive printed circuit ground plane; and a massive conductive plate.

It is appreciated that at least one of the primary electrical winding 110 and the secondary electrical winding 120 may comprise a ribbon cable which is typically a cable made of normal, round, insulated wires arranged side by side and preferably fastened together by a cohesion process to form a flexible ribbon. In such a case, each wire of the ribbon cable is preferably electrically connected, at at least one location, to adjacent wires in the ribbon cable so as to produce a conductive path throughout all wires in the ribbon cable. A MID winding may be created by wrapping a portion of the core 130 with such a ribbon cable. The MID 100 may thus be produced by wrapping a first ribbon cable, in which each wire is electrically connected, at at least one location, to adjacent wires in the first ribbon cable, around a first portion of the ECC 140, and wrapping a second ribbon cable, in which each wire is electrically connected, at at least one location, to adjacent wires in the second ribbon cable, around a second portion of the ECC 140. The first ribbon cable then comprises the primary electrical winding 110 and the second ribbon cable comprises the secondary electrical winding 120.

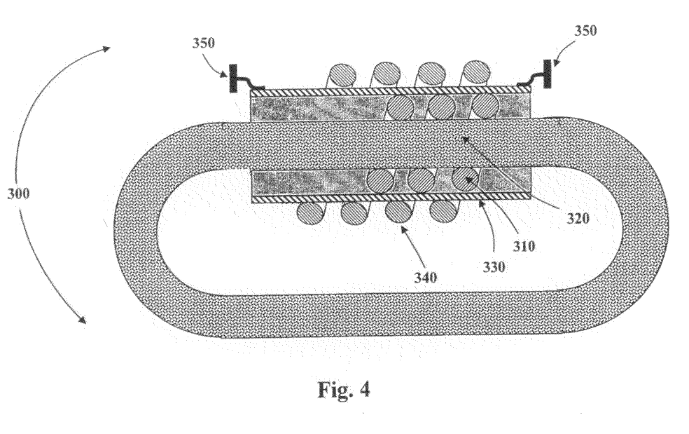

Reference is now made to FIG. 4, which is a simplified pictorial illustration of another preferred implementation of a MID 300 comprising a transformer which has windings one over the other and employs a grounded ECC, the MID 300 being constructed and operative in accordance with a preferred embodiment of the present invention.

The MID 300 may also, for example which is not meant to be limiting, be used as a transformer in various applications including, for example, communication applications. The MID 300 is different from the MID 100 of FIG. 1A in that electrical windings are placed one over the other. In the MID 300 of FIG. 4, a primary electrical winding 310 surrounds a portion of a core 320, and an ECC 330 at least partially surrounds, without forming a closed conductive loop, the primary electrical winding 310. A secondary electrical winding 340 is then preferably wound or otherwise deposited on the ECC 330. It is appreciated that the roles of the primary electrical winding 310 and the secondary electrical winding 340 may be changed so that the winding 310, which is internal to the ECC 330, is used as a secondary electrical winding, and the winding 340, which is external to the ECC 330, is used as a primary electrical winding.

Each of the primary electrical winding 310 and the secondary electrical winding 340 preferably comprises insulated wires or insulated conductors as mentioned above with reference to the windings 110 and 120 of the MID 100 of FIG. 1A.

Preferably, the ECC 330 is electrically connected to a local ground 350, for example, via a connection similar to one of the connections used for electrically connecting the ECC 140 of FIG. 1A to the local ground 150 of FIG. 1A. The local ground 350 is preferably similar to the local ground 150 mentioned above with reference to FIG. 1A.

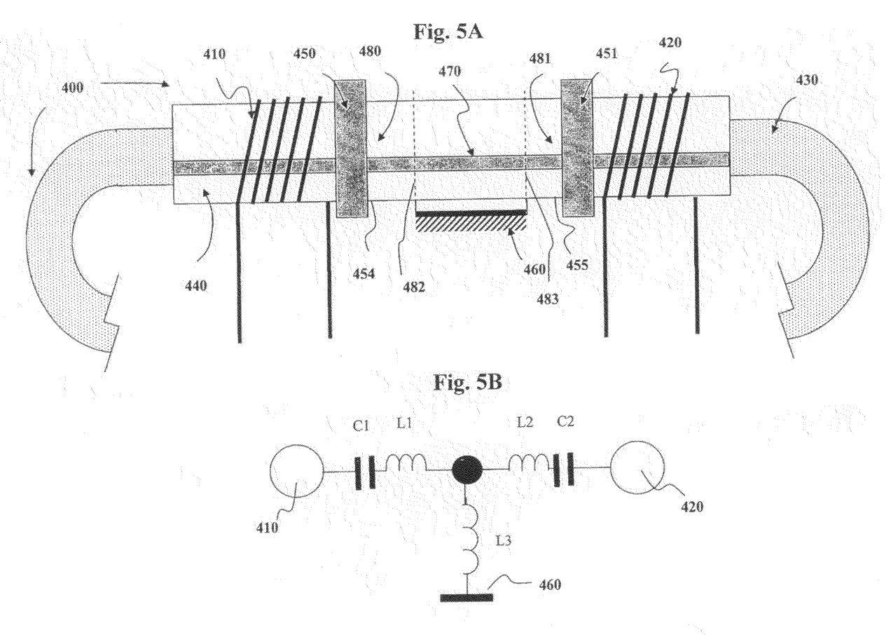

Reference is now made to FIG. 5A, which is a simplified pictorial illustration of still another preferred implementation of a MID 400 comprising a transformer which employs a grounded ECC and sleeves added over the ECC between windings and grounding location, the MID 400 being constructed and operative in accordance with a preferred embodiment of the present invention. The MID 400 may also, for example which is not meant to be limiting, be used as a transformer in various applications including, for example, communication applications.

The NED 400 preferably includes the following elements: at least one primary electrical winding 410; at least one secondary electrical winding 420; a core 430 via which the at least one primary electrical winding 410 and the at least one secondary electrical winding 420 are magnetically coupled; an ECC 440; and sleeves 450 and 451. It is appreciated that each of the at least one primary electrical winding 410 and the at least one secondary electrical winding 420 comprises insulated wires or insulated conductors as mentioned above with reference to the windings 110 and 120 of the MID 100 of FIG. 1A. The ECC 440 may, for example which is not meant to be limiting, comprise metallic material such as copper or aluminum.

For simplicity of description and depiction, only one primary electrical winding 410 and one secondary electrical winding 420 are shown in FIG. 5A and referred to below, but it is appreciated that the number of primary electrical windings and secondary s electrical windings is not meant to be limiting, and rather the MID 400 may include more than one primary electrical winding 410 and/or more than one secondary electrical winding 420.

In accordance with a preferred embodiment of the present invention the ECC 440 is electrically connected to a local ground 460 and at least partially surrounds the core 430 under both the primary electrical winding 410 and the secondary electrical winding 420 without forming a closed conductive loop. In order to prevent formation of the closed conductive loop the ECC 440 preferably includes a gap 470 which may comprise a longitudinal gap.

Preferably, the ECC 440 is electrically connected to the local ground 460 via conductive means, such as conductive soldering material, conductive welding material, and conductive adhesive material, or via a connection similar to one of the connections used for electrically connecting the ECC 140 of FIG. 1A to the local ground 150 of FIG. 1A.

The local ground 460 is preferably similar to the local ground 150 mentioned above with reference to FIG. 1A.

The sleeves 450 and 451 may, for example, comprise ferrite sleeves. The sleeves 450 and 451 are preferably added to increase impedances of ECC sections 454 and 455, respectively. The ECC section 454 is between the winding 410 and a grounding location 482 of the ECC 440, and the ECC section 455 is between the winding 420 and a grounding location 483 of the ECC 440.

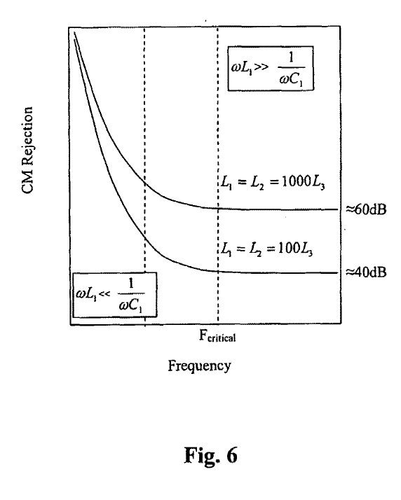

The increase of the impedance of the ECC section 455 by the sleeve 451 enhances common-mode signal rejection at high-frequencies because common-mode currents induced by the primary electrical winding 410 prefer to sink at location 482 into low-impedance ground 460 rather than to flow into relatively high-impedance ECC section 455. Similarly, the increase of the impedance of the ECC section 454 by the sleeve 450 enhances common-mode signal rejection at high frequencies because common-mode currents induced by the secondary electrical winding 420 prefer to sink at location 483 into low-impedance ground 460 rather than to flow into relatively high-impedance ECC section 454. Impact of impedances of the ECC sections 454 and 455 on CM rejection performance is shown in FIG. 6.

Reference is now additionally made to FIG. 5B, which is an illustration of an equivalent circuit applicable for evaluation of common-mode rejection of the MID 400 of FIG. 5A.

In FIG. 5B, C1 is a capacitance between the primary electrical winding 410 and a part of the ECC 440 underlying the primary winding 410, C2 is a capacitance between the secondary electrical winding 420 and a part of the ECC 440 underlying the secondary winding 420, L1 is an inductance of the ECG section 454, L2 is an inductance of the ECC section 455, and L3 is an inductance of a bond or a grounding electrode (not shown) which is used for grounding the ECC 440 to the local ground 460. It is appreciated that the impedances of the ECC sections 454 and 455 may have some real (dissipative) component, particularly when the sleeves 450 and 451 comprises ferrite sleeves. For simplicity, further discussion is done under an assumption that such dissipative components may be neglected.

Typical common-mode rejection performance of the MID 400 of FIG. 5A having the equivalent circuit depicted in FIG. 5B is shown in FIG. 6 in terms of rejection of a common-mode (CM) signal at various frequencies and at different inductance values of L1, L2 and L3. The graph of FIG. 6 is shown in relative units of ratios between L1 and L3, and L2 and L3, under an assumption that L1=L2. It is noted that CM signal rejection at high frequencies, where impedances provided by the capacitances C1 and C2 are much lower than impedances provided by L1 and L2, may be significantly enhanced by increasing the ratio between L1 and L3 (or L2 and L3).

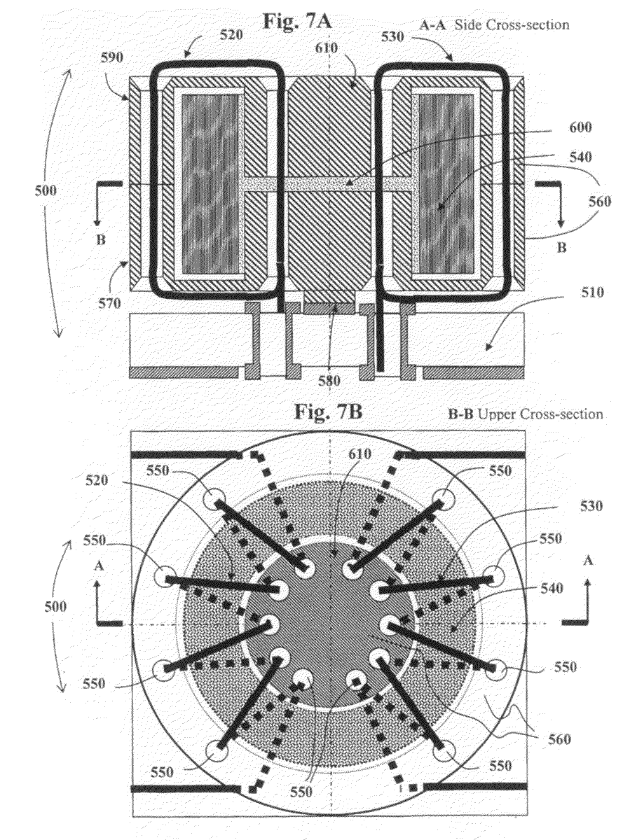

Reference is now made to FIG. 7A, which is a simplified pictorial illustration of a cross-section view of yet another preferred implementation of a MID 500 comprising a transformer which employs a grounded ECC and has a core window which is at least partially filled with a conductive medium, the MID 500 being constructed and operative in accordance with a preferred embodiment of the present invention, and to FIG. 7B, which is a simplified pictorial illustration of a top view of the MID 500 of FIG. 7A. The MID 500 may also, for example which is not meant to be limiting, be used as a transformer in various applications including, for example, communication applications.

In FIG. 7A, the MID 500 is shown installed on a printed-circuit board (PCB) 510. In the MID 500, a primary electrical winding 520 and a secondary electrical winding 530 are preferably wound on a common toroidal core 540 via holes 550 in inner and outer portions of an ECC 560, as shown in FIG. 7B. The primary electrical winding 520 and the secondary electrical winding 530 are preferably magnetically coupled via the core 540. Each of the primary electrical winding 520 and the secondary electrical winding 530 preferably comprises insulated wires or insulated conductors as mentioned above with reference to the windings 110 and 120 of the MID 100 of FIG. 1A.

Preferably, the primary electrical winding 520, the secondary electrical winding 530 and the core 540 are mounted on a lower portion 570 of a metallic capsule, which metallic capsule is used as part of the ECC 560. The lower portion 570 of the ECC 560 is preferably in electrical contact with a ground pad 580 on the PCB 510 and thus the ECC 560 is electrically connected to a local ground (not shown) via the ground pad 580. The ECC 560 also preferably includes an upper portion 590 which covers the core 540 from above. The ECC 560 may also preferably include an additional cover (not shown) which covers the windings 520 and 530 from above, and an additional layer (not shown) between each of the windings 520 and 530 and the PCB 510. It is appreciated that the ECC 560, in its entirety, may, for example which is not meant to be limiting, comprise metallic material such as copper or aluminum.

A gap 600 is preferably maintained between the upper portion 590 and the lower portion 570 in order to prevent formation of a closed conductive loop around the core 540. The gap 600 is preferably arranged in the inner side of the ECC 560 in order to lower leakage of magnetic flux from the gap 600.

Preferably, the core 540 comprises a closed path for magnetic flux defining a window 610 in the core 540. The window 610 preferably comprises the hole of the toroidal core 540. In accordance with a preferred embodiment of the present invention the window 610 is at least partially filled with an electrically conductive medium comprising a part of the ECC 560 and a heat-sink and connected to the local ground (not shown) via the pad 580. The electrically conductive medium may, for example which is not meant to be limiting, comprise copper or aluminum.

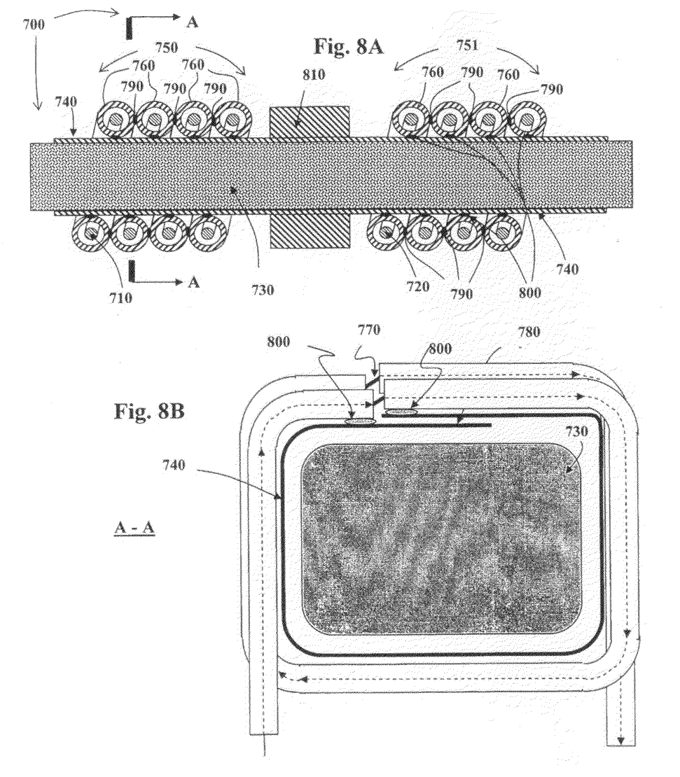

Reference is now made to FIG. 8A, which is a simplified pictorial illustration of another preferred implementation of a MID 700 comprising a transformer which employs a grounded ECC and coaxial cable wiring, the MID 700 being constructed and operative in accordance with a preferred embodiment of the present invention, and to FIG. 5B, which is a simplified pictorial illustration of a cross-section view of the MID 700 of FIG. 8A. The MID 700 may also, for example which is not meant to be limiting, be used as a transformer in various applications including, for example, communication applications.

In the MID 700, at least a portion of at least one of a primary electrical winding 710 and a secondary electrical winding 720 preferably comprises inner conductors of coaxial cables. For simplicity of depiction and description, each of the primary electrical winding 710 and the secondary electrical winding 720 is shown in FIG. 8A as comprising an inner conductor of a coaxial cable. A magnetic core 730, via which the primary electrical winding 710 and the secondary electrical winding 720 are magnetically coupled, is shown, for simplicity of depiction and description but without limiting the generality of the description, as a linear open core.

Preferably, an ECC 740 at least partially surrounds the core 730 under the primary electrical winding 710 and under the secondary electrical winding 720, without forming a closed conductive loop around the core 730.

In accordance with a preferred embodiment of the present invention additional ECCs 750 and 751 are used in the MID 700. The ECCs 750 and 751 preferably comprise outer shielding conductors 760 of sections of the coaxial cables, where the sections of the coaxial cables are arranged to include a gap 770 between each two adjacent coaxial cable sections, as shown in FIG. 813. The gap 770 prevents formation of a closed conductive loop around the core 730. Also shown in FIG. 5B is a gap 780 in the ECC 740. The gap 780 also preferably prevents formation of a closed conductive loop around the core 730.

The outer shielding conductors 760 of the coaxial cables preferably include electrical conductive connections 790 between adjacent sections of the outer shielding conductors 760 of adjacent sections of the coaxial cables, and electrical conductive connections 800 between the outer shielding conductors 760 and the ECC 740 which are preferably located close to the gap 770. The ECC 740 is preferably connected to a local ground 810 via an electrical conductive connection (not shown).

Each of the MID 100 of FIGS. 1A-3, the MID 300 of FIG. 4, the MID 400 of FIG. 5A, the MID 500 of FIGS. 7A and 7B, and the MID 700 of FIGS. 8A and 8B preferably comprises, or is comprised in, at least one of the following: a transformer; a Balun; an electrical power divider; an electrical power splitter; an electrical power combiner; a common-mode (CM) choke; a mixing device based on magnetic induction components; and a modulator.

The modulator may comprise a modulator based on magnetic induction components.

The mixing device may comprise a balanced as well as a double balanced mixing device. The mixing device may be used in radio-frequency (RF) and microwave applications, for example in an RE receiver. Discussion of operation and applications of mixing devices may, for example, be found in Ian Purdie's Amateur Radio Tutorial Pages entitled “Double Balanced Mixers and Baluns”, at http://my.integritynet.com.au/purdic/dbl_bal_mix.htm, or in a description at www.microwaves101.com/encyclopedia/mixersdoublebalanced.cfm.

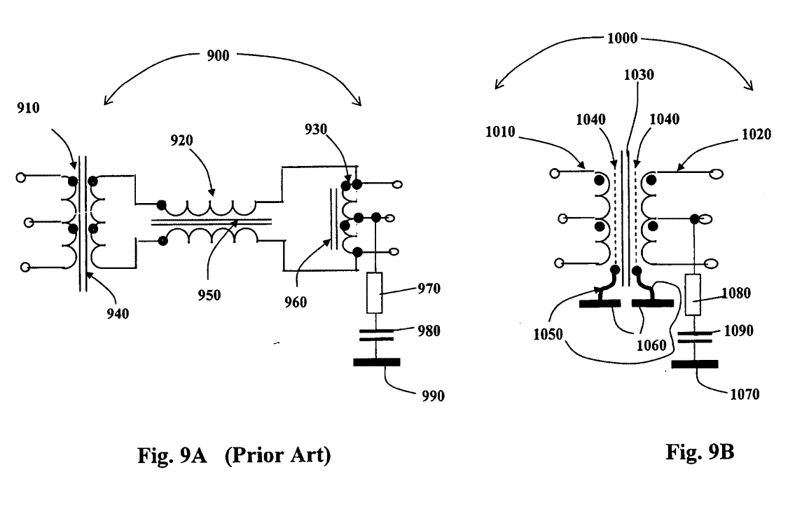

In a case where any of the MIDs 100, 300, 400, 500 and 700 comprises a transformer, such a MID may, for example, be comprised in a line termination unit (LTU) (not shown) of an Ethernet communication system (not shown), where the LTU may, for example which is not meant to be limiting, comprise an RJ45 connector (not shown) integrated with local area network (LAN) magnetics, which RJ45 integrated connector is typically used in LANs or personal area networks (PANs). In such a case, such a MID may preferably be comprised in and/or associated with the RJ45 connector and replace a plurality of conventional transformers, auto-transformers and CM chokes due to its superior performance in rejecting CM signals. Each of the MIDs 100, 300, 400, 500 and 700 may thus reduce complexity of magnetic components in LTUs. An example, which is not meant to be limiting, of reduction of complexity of magnetic components in LTUs for high-frequency applications is described with reference to FIGS. 9A and 9B.

It is appreciated that in contrast with conventional MIDs and conventional MID designs, each of the MIDs 100, 300, 400, 500 and 700 provides both improvement in control of leakage inductance and enhancement of common-mode rejection, all on a single device basis. In each of the MIDs 100, 300, 400, 500 and 700, the respective grounded ECC has dual functionality comprising both of the following: (a) confinement of magnetic flux within a specific volume thus reducing leakage inductance up to relatively high frequencies, and enhancing electromagnetic coupling between primary and secondary windings without need in proximate co-location or interleaving of the primary and secondary windings; and (b) enhancement of common-mode rejection.

Referring now to FIGS. 9A and 9B, FIG. 9A is an illustration of an electrical circuit 900 of a prior art magnetics module for a 100/1000BaseT Ethernet interface circuit that also supports Power-over-Ethernet (POE), and FIG. 9B is an illustration of an electrical circuit 1000 of a MID comprising a transformer which employs a grounded ECC in accordance with a preferred embodiment of the present invention, the electrical circuit 1000 being constructed and operative in accordance with a preferred embodiment of the present invention.

POE is an application considered today for Ethernet communication at data rates of 100 megabit per second, 1 gigabit per second (Gbit/sec) and beyond. The circuit 900 of FIG. 9A shows three MIDs including a line transformer 910 which provides a relatively small amount of CM rejection at frequencies above several tens of MHz, a CM choke 920 for increased CM rejection at frequencies above several tens of MHz, and an auto-transformer 930 having a center tap for direct-current (DC) injection. The auto-transformer 930 is used for preventing DC current flow through windings of the CM choke 920, thus preventing saturation of the CM choke 920. Cores of the line transformer 910, the CM choke 920, and the auto-transformer 930 are indicated by reference numerals 940, 950 and 960, respectively. The auto-transformer 930 has a termination for common-mode signals comprising a resistor 970 and a capacitor 980. Direct ground connection is provided for reference of such R-C termination network to local ground 990.

In accordance with a preferred embodiment of the present invention the circuit 1000 of FIG. 9B includes a single MID having a primary electrical winding 1010, a secondary electrical winding 1020, a core 1030, and an ECC 1040 which is electrically connected to or bonded to a local ground 1060 via electrical connections 1050. The circuit 1000 also has a connection to a local ground 1070 via a common-mode termination resistor 1080 and a capacitor 1090. The connection to the local ground 1070 through the common-mode termination resistor 1080 and the capacitor 1090 is used for the same purpose as the connection to local ground 990 via the resistor 970 and the capacitor 980 in the circuit 900 of FIG. 9A.

The circuit 1000 therefore has two types of local ground connections: a connection to the local ground 1070 having a goal of common-mode termination; and a connection to another local ground 1060 having a goal of enhancing common-mode rejection. It is appreciated that in some practical applications the local ground 1060 and the local ground 1070 may physically comprise the same local ground.

It is appreciated that the circuit 1000 has enhanced CM signal rejection capabilities due to the ECC 1040 and the connection of the ECC 1040 to the local ground 1060 and therefore the single MID of the circuit 1000 can replace all three MIDs of the circuit 900 for LAN and in particular for POE magnetics applications. The inventors of the present invention found that a single MID that employs a grounded ECC in accordance with the present invention can provide more than 60 dB CM signal rejection at frequencies up to 100 MHz, and more than 30 dB CM signal rejection at frequencies up to 1000 MHz (1GHz) whereas commercially available MIDs employing three MIDs as described with reference to FIG. 9A can provide only typically 40 dB CM rejection at frequencies up to 100 MHz and typically up to 20 dB CM signal rejection at frequencies up to 1 GHz. The single MID that employs a grounded ECC in accordance with the present invention has a simpler and cost effective construction and it enables to achieve a better balance and as a result enhanced CM-to-differential mode (DM) conversion parameters with respect to the commercially available MIDs.

The significant differences in CM signal rejection performance between the circuits 900 and 1000 show that a mere grounding of a MID is not sufficient for obtaining a good CM signal rejection performance. The inventors of the present invention found that a significant improvement in CM signal rejection performance of a MID may be obtained by sophisticatedly implementing an ECC in a MID and by electrically connecting the ECC to a local ground as described above with reference to FIGS. 1A, 113, 3-5B, and 7A-8B.

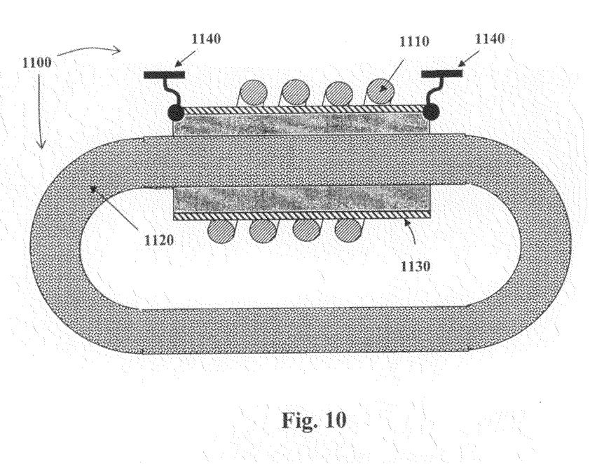

Reference is now made to FIG. 10, which is a simplified pictorial illustration of a preferred implementation of a MID comprising an inductor 1100 which employs a grounded ECC, the MID being constructed and operative in accordance with a preferred embodiment of the present invention.

The inductor 1100 preferably includes the following elements: an electrical winding 1110; a core, such as a magnetic core 1120; and an ECC 1130. The ECC 1130 at least partially surrounds the core 1120 without forming a closed conductive loop, and the electrical winding 1110 is wound on the ECC 1130. The electrical winding 1110 may comprise insulated wires or insulated conductors as mentioned above with reference to the windings 110 and 120 of the MID 100 of FIG. 1A.

It is appreciated that in some practical applications the ECC 1130 may remain floating, that is disconnected from a local ground, thus preventing leakage of magnetic flux from the core 1120 and the winding 1110.

Alternatively, the ECC 1130 may be conductively connected to a local ground 1140 thus providing an additional electrical shield. Connection to the local ground 1140 may, for example, be implemented by a connection similar to one of the connections used for electrically connecting the ECC 140 of FIG. 1A to the local ground 150 of FIG. 1A. The local ground 1140 is preferably similar to the local ground 150 mentioned above with reference to FIG. 1A.

Preferably, each of the ECC 140 of FIGS. 1A-3, the ECC 330 of FIG. 4, the ECC 440 of FIG. 5A, the ECC 560 of FIGS. 7A and 7B, the ECCs 740 and 750 of FIGS. 8A and 8B, the ECC 1040 of FIG. 9B, and the ECC 1130 of FIG. 10 may be implemented in any appropriate way including an implementation as a conductive mesh, an implementation as one or more layers of conductive paint or other conductive deposition, an implementation as a conductive plane, etc. Alternatively or additionally, each of the ECCs 140, 330, 440, 560, 740, 750, 1040 and 1130 may be implemented together with the respective electrical windings by deposition of multiple layers of metal or by electro-chemical forming.

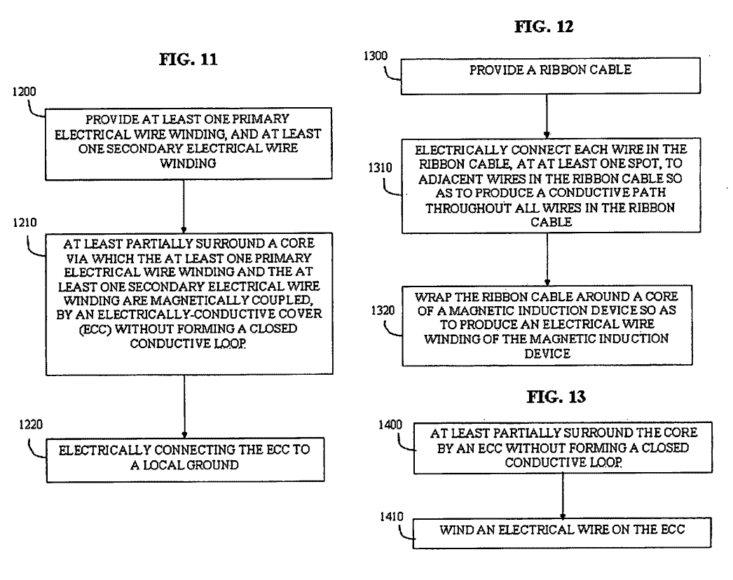

Reference is now made to FIG. 11, which is a simplified flowchart illustration of a preferred method for constructing any of the MIDs of FIGS. 11, 3-5A and 7A-8B.

The method of FIG. 11 may preferably be used to reduce leakage inductance and to enhance CM signal rejection in a magnetic induction device. Preferably, the method of FIG. 11 comprises providing (step 1200) at least one primary electrical winding and at least one secondary electrical winding, at least partially surrounding (step 1210) a core via which the at least one primary electrical winding and the at least one secondary electrical winding are magnetically coupled, by an ECC without forming a closed conductive loop, and electrically connecting (step 1220) the ECC to a local ground.

Reference is now made to FIG. 12, which is a simplified flowchart illustration of a preferred method for constructing a MID having reduced metallic losses and comprising a ribbon cable.

Preferably, the method of FIG. 12 comprises providing (step 1300) a ribbon cable, electrically connecting (step 1310) each wire in the ribbon cable, at at least one location, to adjacent wires in the ribbon cable so as to produce a conductive path throughout all wires in the ribbon cable, and wrapping (step 1320) the ribbon cable around a core of a magnetic induction device so as to produce an electrical winding of the magnetic induction device.

Reference is now made to FIG. 13, which is a simplified flowchart illustration of a preferred method for constructing the inductor 1100 of FIG. 10.

The method of FIG. 13 may preferably be used to reduce leakage inductance in the inductor 1100. Preferably, the method of FIG. 13 comprises at least partially surrounding (step 1400) a core by an ECC without forming a closed conductive loop, and winding (step 1410) an electrical wire on the ECC.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the claims that follow:

1-12. (canceled)

14-16. (canceled)

18-27. (canceled)

28. A magnetic induction device (MID) comprising:
at least one primary electrical winding;
at least one secondary electrical winding; and
an electrically-conductive cover (ECC) at least partially surrounding, without forming a closed conductive loop, a core via which the at least one primary electrical winding and the at least one secondary electrical winding are magnetically coupled,
wherein the ECC is electrically connected to a local ground by an electrical connection having a low impedance in a broad frequency range, the electrical connection enabling diversion of common-mode (CM) currents from the magnetic induction device to the local ground.

29. The magnetic induction device according to claim 28 and wherein the ECC at least partially surrounds the following core sections: a core section surrounded by the at least one primary electrical winding; a core section surrounded by the at least one secondary electrical winding; and a core section between the at least one primary electrical winding and the at least one secondary electrical winding.

30. The magnetic induction device according to claim 29 and wherein the ECC surrounds the core section surrounded by the at least one primary electrical winding under the winding so as to provide a conductive path for surface currents induced by the at least one primary electrical winding from an outer surface of the ECC which is in proximity to the at least one primary electrical winding to an inner surface of the ECC which is in proximity to the core.

31. The magnetic induction device according to claim 29 and wherein the ECC surrounds the core section surrounded by the at least one secondary electrical winding under the winding so as to provide a conductive path for surface currents induced by magnetic flux in the core from an inner surface of the ECC which is in proximity to the core to an outer surface of the ECC which is in proximity to the secondary electrical winding.

32. The magnetic induction device according to claim 29 and wherein the ECC surrounds the core section surrounded by the primary electrical winding and the core section surrounded by the secondary electrical winding from above the windings and is substantially in contact with winding insulation of at least a portion of the windings to substantially prevent leakage of a magnetic flux emanating from the primary electrical winding.

33. The magnetic induction device according to claim 28 and wherein the ECC is electrically connected to the local ground via at least one of the following connections: a direct connection; and a connection via a capacitor.

34. The magnetic induction device according to claim 28 and wherein the local ground comprises at least one of the following: a local conductive chassis ground; a shield of host equipment; a housing of host equipment; a massive printed circuit ground plane; and a massive conductive plate.

35. The magnetic induction device according to claim 28 and comprising at least one of the following: a transformer; a Balun; an electrical power divider; an electrical power splitter; an electrical power combiner; a common-mode (CM) choke; a mixing device based on magnetic induction components; and a modulator.

36. The magnetic induction device according to claim 28 and wherein the ECC is electrically connected to the local ground at least at a location along a core section which is between the at least one primary electrical winding and the at least one secondary electrical winding.

37. The magnetic induction device according to claim 28 and wherein the core comprises a closed path for magnetic flux defining a window in the core, the window being at least partially filled with an electrically conductive medium comprising a heat-sink and connected to the local ground.

38. The magnetic induction device according to claim 28 and wherein at least one of the at least one primary electrical winding and the at least one secondary electrical winding comprises a ribbon cable in which each wire is electrically connected, at at least two locations, to each adjacent wire in the ribbon cable so as to electrically connect in parallel all wires in the ribbon cable.

39. The magnetic induction device according to claim 28 and wherein at least one of the at least one primary electrical winding and the at least one secondary electrical winding comprises an insulated conductor produced by a metal deposition technique used for depositing a conductor followed by deposition of an insulation layer that insulates the conductor.

40. A line termination unit (LTU) which is used in Ethernet communication and comprising the magnetic induction device of claim 28.

41. A magnetic induction device comprising:
a primary electrical winding comprising a first ribbon cable in which each wire is electrically connected, at at least two locations, to each adjacent wire in the first ribbon cable so as to electrically connect in parallel all wires in the first ribbon cable; and
a secondary electrical winding comprising a second ribbon cable in which each wire is electrically connected, at at least two locations, to each adjacent wire in the second ribbon cable so as to electrically connect in parallel all wires in the second ribbon cable.

42. A line termination unit (LTU) which is used in Ethernet communication and comprising the magnetic induction device of claim 41.

43. An inductor comprising:
an electrically-conductive cover (ECC) which is electrically connected to a local ground and at least partially surrounds a core without forming a closed conductive loop; and
an electrical winding wound on the ECC.

44. A method of enhancing common-mode (CM) rejection in a magnetic induction device, the method comprising:
providing at least one primary electrical winding, and at least one secondary electrical winding;
at least partially surrounding a core via which the at least one primary electrical winding and the at least one secondary electrical winding are magnetically coupled, by an electrically-conductive cover (ECC) without forming a closed conductive loop; and
electrically connecting the ECC to a local ground by an electrical connection having a low impedance in a broad frequency range, the electrical connection enabling diversion of CM currents from the magnetic induction device to the local ground.

45. A method of reducing leakage inductance in a magnetic induction device, the method comprising:
providing a ribbon cable;
electrically connecting each wire in the ribbon cable, at at least two locations, to each adjacent wire in the ribbon cable so as to electrically connect in parallel all wires in the ribbon cable; and
wrapping the ribbon cable around a core of a magnetic induction device so as to produce an electrical winding of the magnetic induction device.

46. A method for reducing crosstalk between an inductor and nearby electronic components, the method comprising:
at least partially surrounding a core by an electrically-conductive cover (ECC) without forming a closed conductive loop;
winding an electrical winding on the ECC; and
electrically connecting the ECC to a local ground by an electrical connection having a low impedance in a broad frequency range, the electrical connection enabling diversion of CM currents from the inductor to the local ground.

47. The magnetic induction device according to claim 28 and wherein the ECC at least partially surrounds a core section surrounded by at least a portion of the at least one primary electrical winding from above the primary electrical winding, and at least a portion of the at least one secondary electrical winding under the secondary electrical winding.

48. The magnetic induction device according to claim 28 and wherein the ECC at least partially surrounds a core section surrounded by at least a portion of the at least one secondary electrical winding from above the secondary electrical winding, and at least a portion of the at least one primary electrical winding under the primary electrical winding.

49. The magnetic induction device according to claim 47 and wherein the ECC is substantially in contact with winding insulation of at least a portion of the at least one primary electrical winding to substantially prevent leakage of a magnetic flux emanating from the at least one primary electrical winding.

50. The magnetic induction device according to claim 28 and wherein the ECC is electrically connected to the local ground at more than one location.

51. The magnetic induction device according to claim 28 and wherein one of the at least one primary electrical winding and the at least one secondary electrical winding carries differential-mode (DM) signals.

52. The magnetic induction device according to claim 28 and wherein the at least one primary electrical winding and the at least one secondary electrical winding carry DM signals.

53. The magnetic induction device according to claim 28 and wherein:
each turn of at least one of the at least one primary electrical winding and the at least one secondary electrical winding comprises an inner conductor of a section of a coaxial cable and an outer shielding conductor of the section of the coaxial cable, the outer shielding conductor of the section of the coaxial cable comprising a first outer shielding conductor end and a second outer shielding conductor end,
wherein the second outer shielding conductor end of each section of the coaxial cable is electrically disconnected from the first outer shielding conductor end of a subsequent section,
wherein the first outer shielding conductor ends of all adjacent sections of the coaxial cable are conductively connected between them, and the second outer shielding conductor ends of all adjacent sections of the coaxial cable are conductively connected between them, and
the ECC is conductively connected to outer shielding conductors of all adjacent coaxial cable sections.

54. A magnetic induction device (MID) comprising:
primary means for winding;
secondary means for winding; and
means for at least partially surrounding, without forming a closed conductive loop, a core via which the primary means for winding and the secondary means for winding are magnetically coupled,
wherein the means for at least partially surrounding is electrically connected to a local ground by an electrical connection having a low impedance in a broad frequency range, the electrical connection enabling diversion of common-mode (CM) currents from the magnetic induction device to the local ground.

55. A magnetic induction device comprising:
primary means for winding comprising a first ribbon cable in which each wire is electrically connected, at at least two locations, to each adjacent wire in is the first ribbon cable so as to electrically connect in parallel all wires in the first ribbon cable; and
secondary means for winding comprising a second ribbon cable in which each wire is electrically connected, at at least two locations, to each adjacent wire in the second ribbon cable so as to electrically connect in parallel all wires in the second ribbon cable.

56. An inductor comprising:
means for at least partially surrounding a core without forming a closed conductive loop, the means for at least partially surrounding being electrically connected to a local ground; and
means for winding wound on the means for at least partially surrounding.
